(19) United States
(12) Patent Application Publication
(10) Pub. No.: US 2025/0274019 A1
(43) Pub. Date: Aug. 28, 2025

(54) ELECTRIC MOTOR AND MOTOR-DRIVEN COMPRESSOR

(71) Applicant: KABUSHIKI KAISHA TOYOTA JIDOSHOKKI, Kariya-shi (JP)

(72) Inventors: Takuya NARUSE, Kariya-shi (JP); Takashi KAWASHIMA, Kariya-shi (JP)

(73) Assignee: KABUSHIKI KAISHA TOYOTA JIDOSHOKKI, Kariya-shi (JP)

(21) Appl. No.: 19/057,528

(22) Filed: Feb. 19, 2025

(30) Foreign Application Priority Data
Feb. 27, 2024 (JP) 2024-027574
Dec. 25, 2024 (JP) 2024-228939

(51) Int. Cl. H02K 11/21; H02K 11/25; H02K 11/27

(52) U.S. Cl. CPC H02K 11/21; H02K 11/25; H02K 11/27

(57) ABSTRACT

An electric motor includes processing circuitry. The processing circuitry is configured to superpose a harmonic on at least one of instruction values, and estimate the position of a rotor by a harmonic superposition method based on the harmonic superposed on the at least one of instruction values. The frequency of a harmonic includes a first frequency and a second frequency that is lower than the first frequency. The processing circuitry is further configured to determine whether a temperature-associated value becomes greater than a threshold value. When the temperature-associated value becomes greater than the threshold value, the processing circuitry is further configured to set the frequency of the harmonic for superposition on the at least one of instruction values to the second frequency.

### CROSS-REFERENCE TO RELATED APPLICATIONS

This application is based upon and claims the benefit of priority from Japanese Patent Application No. 2024-027574, filed on Feb. 27, 2024, and Japanese Patent Application No. 2024-228939, filed on Dec. 25, 2024, the entire contents of which are incorporated herein by reference.

### BACKGROUND

### 1. Field

The following description relates to an electric motor and a motor-driven compressor.

### 2. Description of Related Art

When a motor is driven by sensorless control, the position of a rotor of the motor needs to be estimated by a controller. Sensorless control is a control method that drives a motor without using a hardware position sensor and estimates the position of a rotor using software.

A typical method for estimating the position of a rotor includes, for example, an induced voltage method and a harmonic superposition method. The induced voltage method estimates the position of a rotor based on an induced voltage generated by rotation of a motor. Japanese Laid-Open Patent Publication No. 2011-172324 describes a harmonic superposition method that estimates the position of a rotor based on a current (response current) flowing through a motor when a harmonic component is superposed on a voltage instruction value or a current instruction value to the motor.

### SUMMARY

A motor loss may increase as the frequency of a carrier (carrier wave) for pulse width modulation (PWM) control of the motor and the frequency of a harmonic superposed for position estimation of a rotor become higher. In contrast, a decrease in the frequency of the harmonic may adversely affect the noise and vibration (NV) characteristics. Nonetheless, the above publication is mute on specific settings of the frequency of the harmonic.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electric motor includes a motor unit, an inverter, a temperature-associated value obtainer, and processing circuitry. The motor unit includes a rotor and a stator around which three-phase coils are wound. The inverter includes a driver and a switching element operated by the driver. The inverter is configured to drive the motor unit through operation of the switching element. The temperature-associated value obtainer is configured to obtain a temperature-associated value that is associated with a temperature of the motor unit. The processing circuitry is configured to calculate instruction values for control of the switching element and control the switching element. The processing circuitry is configured to superpose a harmonic on at least one of the instruction values. The processing circuitry is configured to estimate a position of the rotor by a harmonic superposition method based on the harmonic superposed on the at least one of instruction values. A frequency of the harmonic includes a first frequency and a second frequency that is lower than the first frequency. The processing circuitry is further configured to determine whether the temperature-associated value becomes greater than a threshold value. The processing circuitry is further configured to set the frequency of the harmonic for superposition on the at least one of the instruction values to the second frequency when the temperature-associated value becomes greater than the threshold value.

In another general aspect, a motor-driven compressor includes a compression unit configured to compress a fluid, and the above-described electric motor configured to drive the compression unit.

Other features and aspects will be apparent from the following detailed description, the drawings, and the claims.

### BRIEF DESCRIPTION OF THE DRAWINGS

FIG. 1 is a diagram showing an example of the configuration of a vehicle air conditioner.

FIG. 2 is a graph illustrating the relationship of a frequency of a harmonic switched by a controller of the vehicle air conditioner shown in FIG. 1 and an effective value of a phase current.

FIG. 3 is a flowchart illustrating an example of the series of processes executed by the controller of the vehicle air conditioner shown in FIG. 1 to control a motor unit.

FIG. 4 is a flowchart illustrating an example of the series of processes executed by the controller of the vehicle air conditioner shown in FIG. 1 to set the frequency of the harmonic.

FIG. 5 is a graph illustrating the relationship of a frequency of a harmonic switched by a controller of a modified example and an effective value of a phase current.

FIG. 6 is a flowchart illustrating an example of the series of processes executed by the controller of the modified example to set the frequency of the harmonic.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### Embodiment

An embodiment of an electric motor and a motor-driven compressor will now be described with reference to the drawings.

### Overall Configuration

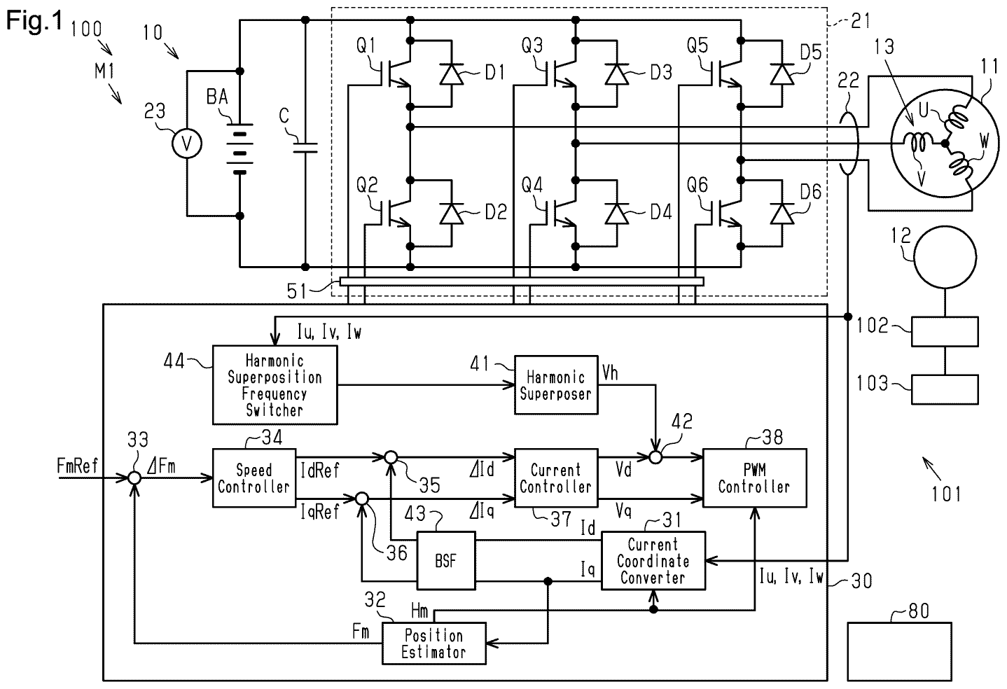

As shown in FIG. 1, a vehicle air conditioner 100 of the present embodiment includes a motor-driven compressor 101 and a refrigerant circuit 103. The motor-driven compressor 101 includes a compression unit 102 and an electric motor M1. The motor-driven compressor 101 compresses refrigerant. The refrigerant circuit 103 includes, for example, a heat exchanger, an expansion valve, or the like. The motor-driven compressor 101 compresses refrigerant, and the refrigerant circuit 103 exchanges heat with the refrigerant and expands the refrigerant. This allows the vehicle air conditioner 100 to cool or warm the passenger compartment. The motor-driven compressor 101 discharges oil together with the compressed refrigerant.

The compression unit 102 compresses refrigerant. The refrigerant compressed by the compression unit 102 is discharged to the refrigerant circuit 103. The compression unit 102 may be of any type, such as a scroll type, a piston type, a vane type, or the like.

### Electric Motor

The electric motor M1 includes a motor unit 11. The motor unit 11 includes a rotor 12 and a stator 13 around which three-phase coils U, V, and W are wound. The motor unit 11 is a three-phase motor including three coils U, V, and W. The motor unit 11 drives the compression unit 102. The motor unit 11 may be cooled by the refrigerant circulated through the refrigerant circuit 103.

The electric motor M1 includes a motor driving device 10. The motor driving device 10 includes a battery BA, a smoothing capacitor C, an inverter 21, a phase current detector 22, an input voltage detector 23, and a controller 30.

The inverter 21 includes six switching elements Q1 to Q6, diodes D1 to D6, and a driver 51. The switching elements Q1 to Q6 are, for example, insulated gate bipolar transistors (IGBTs). When the switching elements Q1 to Q6 are metal-oxide-semiconductor field-effect transistors (MOSFETs), the switching elements Q1 to Q6 are integrated with the diodes D1 to D6. The switching elements Q1 and Q2 are connected in series to each other. The switching elements Q3 and Q4 are connected in series to each other. The switching elements Q5 and Q6 are connected in series to each other. The switching elements Q1 to Q6 are connected in parallel to the diodes D1 to D6, respectively. The switching elements Q1 to Q6 are each connected to the battery BA via the smoothing capacitor C.

A connection line connecting the switching elements Q1 and Q2 branches off and is connected to the coil U. A connection line connecting the switching elements Q3 and Q4 branches off and is connected to the coil V. A connection line connecting the switching elements Q5 and Q6 branches off and is connected to the coil W.

The driver 51 operates the switching elements Q1 to Q6. The operation of the switching elements Q1 to Q6 drives the motor unit 11. The operation of the switching elements Q1 to Q6 refers to switching operations of the switching elements Q1 to Q6, that is, switching of the switching elements Q1 to Q6 between on and off states.

The battery BA is a power storage device that can be charged and discharged. The rated voltage of the battery BA is, for example, 800V.

The phase current detector 22 detects a phase current flowing through the motor unit 11. The phase current detector 22 detects phase currents of at least two phases. In the present embodiment, the phase current detector 22 detects a u-phase current Iu, a v-phase current Iv, and a w-phase current Iw. In another embodiment, the phase current detector 22 may detect phase currents of two phases and calculate a phase current of the remaining phase from the two detected phase currents, taking consideration that the sum of phase currents of the three phases equals zero. The u-phase current Iu, the v-phase current Iv, and the w-phase current Iw are actual currents flowing through the coils U, V, and W of the motor unit 11.

The input voltage detector 23 detects an input voltage Vi applied to the inverter 21 by the battery BA.

### Controller

The controller 30 includes a processor and memory 80. The processor is, for example, a central processing unit (CPU), a graphics processing unit (GPU), or a digital signal processor (DSP). The memory 80 includes a random-access memory (RAM) and a read-only memory (ROM). The memory 80 stores program codes or instructions configured to cause the processor to execute processes. The memory 80, which is a computer-readable medium, includes any medium accessible by a general-purpose computer or a special-purpose computer. The controller 30 may include a hardware circuit, such as an application-specific integrated circuit (ASIC), a field-programmable gate array (FPGA), or the like. The controller 30, which is processing circuitry, may include one or more processors that operate according to computer programs, one or more hardware circuits (e.g., ASIC or FPGA), or a combination of the above.

The controller 30 calculates instruction values. The controller 30 uses the instruction values to control the switching elements Q1 to Q6. The controller 30 drives the motor unit 11 by controlling the inverter 21. In the present embodiment, the controller 30 performs sensorless control that drives the motor unit 11 without using a hardware position sensor that detects a position Hm of the rotor 12 of the motor unit 11. The controller 30 controls the inverter 21 while switching between position estimation using an induced voltage method and position estimation using a harmonic superposition method. The induced voltage method estimates the position Hm of the rotor 12 based on an induced voltage generated in the three-phase coils U, V, and W. The harmonic superposition method estimates the position Hm of the rotor 12 based on an actual current (response current) flowing through the motor unit 11 when a harmonic is superposed on an instruction value. Such control on the inverter 21 drives the motor unit 11. Position estimation by the induced voltage method and position estimation by the harmonic superposition method will now be described. Details of a process executed by the controller 30 to switch the two methods will be described later.

### Position Estimation by Induced Voltage Method

The functionality of the controller 30 when performing position estimation by the induced voltage method is described below. The controller 30 includes a current coordinate converter 31, a position estimator 32, subtractors 33, 35, and 36, a speed controller 34, a current controller 37, and a PWM controller 38.

The current coordinate converter 31 converts phase currents Iu, Iv, and Iw to a d-axis current Id and a q-axis current Iq based on the position Hm of the rotor 12 estimated by the position estimator 32. For example, the current coordinate converter 31 converts the phase currents Iu, Iv, and Iw of a three-phase (U, V, and W) fixed coordinate system into currents Iα and Iβ of a two-phase (α and β) fixed coordinate system. The current coordinate converter 31 uses the position Hm to convert the currents Iα and Iβ into the d-axis current Id and the q-axis current Iq of a two-phase (d and q) rotating coordinate system. The d-axis and the q-axis are coordinate axes of a d-q coordinate system that rotates together with the rotor 12 of the motor unit 11. The current coordinate converter 31 may directly convert the phase currents Iu, Iv, and Iw to the d-axis current Id and the q-axis current Iq, without converting them to the currents Iα and Iβ.

The position estimator 32 estimates the position Hm of the rotor 12 of the motor unit 11 based on the d-axis current Id and the q-axis current Iq output from the current coordinate converter 31, and a d-axis voltage instruction value Vd and a q-axis voltage instruction value Vq output from the current controller 37. For example, the position estimator 32 calculates an induced voltage generated in the coils U, V, and W based on the d-axis current Id and the q-axis current Iq, the d-axis voltage instruction value Vd and the q-axis voltage instruction value Vq obtained from the current controller 37, and a constant determined by the motor unit 11. Then, the position estimator 32 estimates the position Hm based on the induced voltage. Further, the position estimator 32 estimates a rotation speed Fm of the rotor 12 based on the estimated position Hm. To facilitate understanding, arrows indicating the d-axis current Id, the d-axis voltage instruction value Vd, and the q-axis voltage instruction value Vq input to the position estimator 32 are not shown in FIG. 1.

The position estimator 32 uses the induced voltage method to estimate the position of the rotor 12 while the estimated rotation speed Fm is greater than or equal to a predetermined rotation speed Fmth. The position estimator 32 uses the harmonic superposition method to estimate the position of the rotor 12 while the estimated rotation speed Fm is less than the predetermined rotation speed Fmth. For example, the predetermined rotation speed Fmth is a value indicating a rotation speed of the rotor 12 that allows for position estimation of rotor 12 by the induced voltage method. The predetermined rotation speed is, for example, approximately 700 rpm.

The subtractor 33 calculates a difference ΔFm between the rotation speed Fm estimated by the position estimator 32 and a rotation speed instruction value FmRef. The rotation speed instruction value FmRef is an instruction value of the rotation speed of the rotor 12 input from outside. For example, the controller 30 receives the rotation speed instruction value FmRef from a higher-level vehicle control device.

The speed controller 34 calculates a d-axis current instruction value IdRef and a q-axis current instruction value IqRef based on the difference ΔFm. For example, the speed controller 34 performs feedback control to calculate the d-axis current instruction value IdRef and the q-axis current instruction value IqRef so that the difference ΔFm converges to zero. The feedback control is, for example, proportional-integral control.

The subtractor 35 calculates a difference ΔId between the d-axis current instruction value IdRef and the d-axis current Id. The subtractor 36 calculates a difference ΔIq between the q-axis current instruction value IqRef and the q-axis current Iq.

The current controller 37 calculates the d-axis voltage instruction value Vd based on the difference ΔId. The current controller 37 calculates the q-axis voltage instruction value Vq based on the difference ΔIq. For example, the current controller 37 performs feedback control to calculate the d-axis voltage instruction value Vd and the q-axis voltage instruction value Vq so that the difference ΔId and the difference ΔIq converge to zero. The feedback control is, for example, proportional-integral control.

The PWM controller 38 converts the d-axis voltage instruction value Vd and the q-axis voltage instruction value Vq to a u-phase voltage instruction value Vu, a v-phase voltage instruction value Vv, and a w-phase voltage instruction value Vw based on the position Hm of the rotor 12 estimated by the position estimator 32 and the input voltage Vi. For example, the PWM controller 38 converts the d-axis voltage instruction value Vd and the q-axis voltage instruction value Vq of the d-q coordinate system to voltage instruction values Vα and Vβ of a α-β coordinate system. The PWM controller 38 converts the two-phase voltage instruction values Vα and Vβ to three-phase voltage instruction values Vu, Vv, and Vw. The PWM controller 38 may directly convert the d-axis voltage instruction value Vd and the q-axis voltage instruction value Vq to the voltage instruction values Vu, Vv, and Vw, without converting them to the voltage instruction values Vα and Vβ.

The inverter 21 is controlled based on the voltage instruction values Vu, Vv, and Vw. Specifically, the PWM controller 38 calculates a duty instruction value based on the voltage instruction values Vu, Vv, and Vw. Subsequently, the PWM controller 38 compares the duty instruction value with a carrier (carrier wave), such as a triangular wave, a sawtooth wave, or the like, to generate a PWM signal having a duty ratio that indicates the duty instruction value. The PWM signal is a gate-on-off signal that determines the ON-OFF states of the switching elements Q1 to Q6. The controller 30 controls the switching elements Q1 to Q6 by outputting the PWM signal to corresponding switching elements Q1 to Q6 via the driver 51.

### Position Estimation by Harmonic Superposition Method

The functionality of the controller 30 when performing position estimation by the harmonic superposition method will now be described. As shown in FIG. 1, in addition to the configuration described above, the controller 30 further includes a harmonic superposer 41, an adder 42, a band-stop filter 43, and a harmonic superposition frequency switcher 44. The current coordinate converter 31, the subtractors 33, 35, 36, the speed controller 34, the current controller 37, and the PWM controller 38 have the same functionalities as in the induced voltage method. Thus, these components will not be described.

The harmonic superposer 41 generates a harmonic Vh. The harmonic Vh is defined by Va*cos2πft. The “Va” represents the amplitude of the harmonic Vh, and the “f” represents the frequency of the harmonic Vh. For example, the frequency f is not dependent on the rotation of the motor unit 11.

The adder 42 adds the harmonic Vh generated by the harmonic superposer 41 to the d-axis voltage instruction value Vd. This superposes the harmonic Vh on the d-axis voltage instruction value Vd. In the present embodiment, the controller 30 superposes the harmonic Vh on only the d-axis voltage instruction value Vd. When the position estimator 32 estimates the position of the rotor 12 by the induced voltage method, the harmonic superposer 41 does not superpose the harmonic Vh on the d-axis voltage instruction value Vd. In another embodiment, the controller 30 may estimate the position of the rotor 12 by superposing the harmonic Vh on both the d-axis voltage instruction value Vd and the q-axis voltage instruction value Vq, both the d-axis current instruction value IdRef and the q-axis current instruction value IqRef, or a predetermined instruction value specified by three-phase voltage instruction values Vu, Vv, and Vw.

The band-stop filter 43 removes a frequency component of a specific band from the d-axis current Id and the q-axis current Iq. When the harmonic superposer 41 superposes the harmonic Vh on the d-axis voltage instruction value Vd, the d-axis current Id and the q-axis current Iq contain frequency components based on the harmonic Vh. The band-stop filter 43 removes such frequency components.

As described above, the position estimator 32 estimates the position of the rotor 12 using the harmonic superposition method while the estimated rotation speed Fm is less than the predetermined rotation speed Fmth. Specifically, the position estimator 32 estimates the position Hm of the rotor 12 and the rotation speed Fm of the rotor 12 from the q-axis current Iq calculated by the current coordinate converter 31. When the harmonic Vh is superposed on the d-axis voltage instruction value Vd, the q-axis current Iq contains a current harmonic based on the harmonic Vh. The position estimator 32 estimates the position Hm of the rotor 12 and the rotation speed Fm of the rotor 12 based on the current harmonic contained in the q-axis current Iq and a mathematical expression model of the motor unit 11. For example, the position estimator 32 calculates an axis error Δθc from the current harmonic. The axis error Δθc is a difference between the actual position Hm of the rotor 12 and the position Hm of the rotor 12 recognized by the controller 30. The position estimator 32 estimates the position Hm of the rotor 12 and the rotation speed Fm of the rotor 12 so that the axis error Δθc becomes equal to zero.

The harmonic superposition frequency switcher 44 switches the frequency of the harmonic Vh based on the phase currents Iu, Iv, and Iw detected by the phase current detector 22 and a first threshold value Th1.

### Relationship between Frequency of Harmonic Vh and First Threshold Value Th1

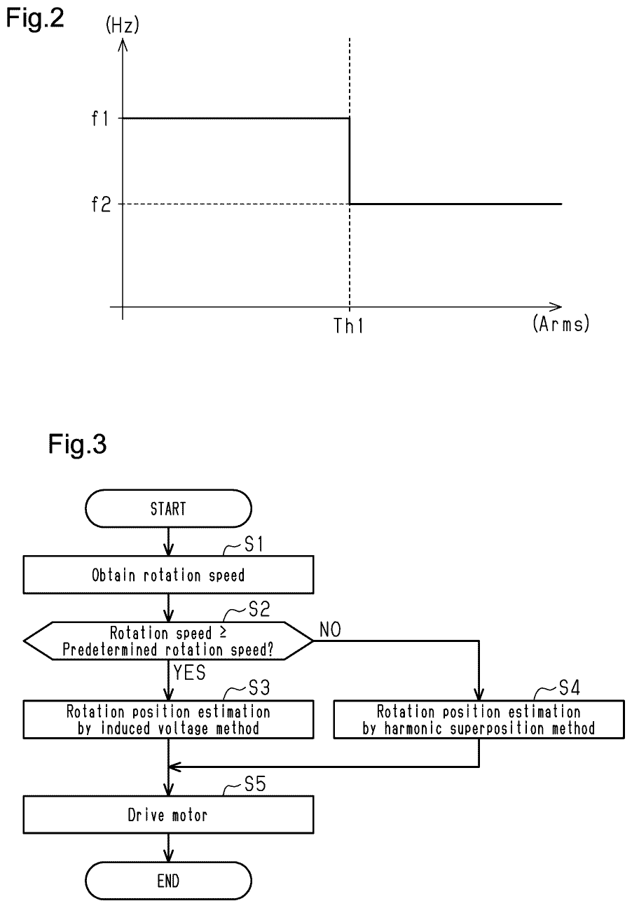

FIG. 2 is a graph illustrating the relationship between the frequency of the harmonic Vh and an effective value of the phase current of the motor unit 11. The frequency of the harmonic Vh includes a first frequency f1 and a second frequency f2. The second frequency f2 is lower than the first frequency f1. In the description hereafter, the first frequency f1 may be referred to as the initial superposition frequency.

As shown in FIG. 2, while each of the phase currents Iu, Iv, and Iw of the motor unit 11 is in a range of zero to the first threshold value Th1, the harmonic superposition frequency switcher 44 causes the harmonic superposer 41 to generate the harmonic Vh having the first frequency f1 so that the harmonic Vh having the first frequency f1 is superposed on the d-axis voltage instruction value Vd. When any of the phase currents Iu, Iv, and Iw detected by the phase current detector 22 becomes greater than the first threshold value Th1, the harmonic superposition frequency switcher 44 switches the frequency of the harmonic Vh, which is to be generated by the harmonic superposer 41, from the first frequency f1 to the second frequency f2. As a result, the harmonic Vh having the second frequency f2 is superposed on the d-axis voltage instruction value Vd. The first threshold value Th1 is based on the heat resistance temperature of the motor unit 11. The first threshold value Th1 indicates a phase current value when the temperature of the motor unit 11 is higher than the average temperature of the motor unit 11 in a normal state by a predetermined value.

As the phase currents Iu, Iv, and Iw of the motor unit 11 increase, the temperature of the motor unit 11 increases. That is, the phase currents Iu, Iv, and Iw of the motor unit 11 correlate with the temperature of the motor unit 11. Therefore, the phase current detector 22 is an example of a temperature-associated value obtainer, and a detection result of the phase currents Iu, Iv, and Iw is an example of a temperature-associated value that is associated with the temperature of the motor unit 11. In other words, a process that determines whether any of the phase currents Iu, Iv, and Iw detected by the phase current detector 22 becomes greater than the first threshold value Th1 is an example of a process that determines whether the temperature of the motor unit 11 becomes greater than the first threshold value Th1.

### Process of Controller 30

The series of processes executed by the controller 30 to control the motor unit 11 will now be described with reference to FIG. 3. The process of the flowchart shown in FIG. 3 is executed in predetermined calculation cycles from when the motor unit 11 is started to when the motor unit 11 is stopped. For example, the motor unit 11 is started when the vehicle air conditioner 100 is started, and is stopped when the vehicle air conditioner 100 is stopped.

In the series of processes related to the control of the motor unit 11, the controller 30 first obtains the rotation speed Fm of the rotor 12 (step S1). In the initial calculation cycle after the motor unit 11 is started, the controller 30 may estimate the rotation speed Fm using the harmonic superposition method or the induced voltage method.

Next, the controller 30 determines whether the rotation speed Fm is greater than or equal to the predetermined rotation speed Fmth (step S2). When the rotation speed Fm is greater than or equal to the predetermined rotation speed Fmth (step S2: YES), the controller 30 uses the induced voltage method to estimate the rotation position of the rotor 12 (step S3). When the rotation speed Fm is less than the predetermined rotation speed Fmth (step S2: NO), the controller 30 uses the harmonic superposition method to estimate the rotation position of the rotor 12 (step S4). Subsequently, the controller 30 generates a PWM signal based on the rotation speed Fm estimated in step S3 or step S4, and then controls the inverter 21 to drive the motor unit 11 (step S5).

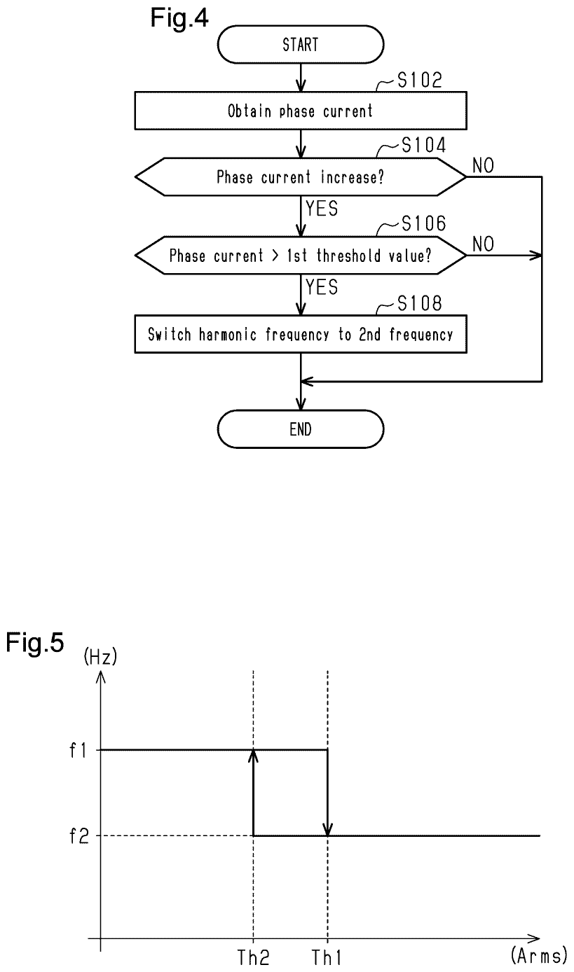

Also, the controller 30 executes the series of processes illustrated in FIG. 4, simultaneously with the flowchart in FIG. 3, to set the frequency of the harmonic Vh. The process of the flowchart shown in FIG. 4 may be executed in the same calculation cycles as the flowchart in FIG. 3, or may be executed in different calculation cycles. The process of the flowchart shown in FIG. 4 does not have to be executed simultaneously with the flowchart in FIG. 3. For example, the process of the flowchart shown in FIG. 4 may be a subroutine executed within the flowchart in FIG. 3 (for example, executed before step S4).

When the motor unit 11 is started, the frequency of the harmonic Vh is set to the initial superposition frequency (first frequency f1). Therefore, if the motor unit 11 was stopped after the frequency of the harmonic Vh had been switched to the second frequency f2, the frequency of the harmonic Vh is switched from the second frequency f2 to the initial superposition frequency when the motor unit 11 is started again.

In the series of processes related to the setting of the frequency of the harmonic Vh, the phase current detector 22 first obtains the phase currents Iu, Iv, and Iw (step S102). Next, the harmonic superposition frequency switcher 44 determines whether the phase currents Iu, Iv, and Iw are increased based on the detection result of the phase current detector 22 (step S104). When none of the phase currents Iu, Iv, and Iw is increased (step S104: NO), there is no need to switch the frequency of the harmonic Vh. Thus, the harmonic superposition frequency switcher 44 ends the series of processes.

When the harmonic superposition frequency switcher 44 determines that any of the phase currents Iu, Iv, and Iw is increased (step S104: YES), the harmonic superposition frequency switcher 44 determines whether any of the phase currents Iu, Iv, and Iw has become greater than the first threshold value Th1 (step S106). When the harmonic superposition frequency switcher 44 determines that none of the phase currents Iu, Iv, and Iw has become greater than the first threshold value Th1 (step S106: NO), the harmonic superposition frequency switcher 44 ends the series of processes. When the harmonic superposition frequency switcher 44 determines that any of the phase currents Iu, Iv, and Iw has become greater than the first threshold value Th1 (step S106: YES), the harmonic superposition frequency switcher 44 switches the frequency of the harmonic Vh from the first frequency f1 to the second frequency f2 (step S108). In this manner, the harmonic superposer 41 superposes the harmonic Vh having the second frequency f2 on the d-axis voltage instruction value Vd. Then, the controller 30 ends the series of processes.

### Advantages of the Embodiment

The above embodiment has the following advantages.
(1) The position estimator 32 estimates the position of the rotor 12 by the harmonic superposition method. The frequency of the harmonic Vh is set to the first frequency f1 when the motor unit 11 is started. When any of the phase currents Iu, Iv, and Iw exceeds the first threshold value Th1, the harmonic superposition frequency switcher 44 determines that the temperature of the motor unit 11 has become greater than the first threshold value. Then, the harmonic superposition frequency switcher 44 switches the frequency of the harmonic Vh, which is to be superposed on the d-axis voltage instruction value Vd, from the first frequency f1 to the second frequency f2.

With this configuration, the frequency of the harmonic Vh is set relatively high when position estimation of the rotor 12 by the harmonic superposition method is started. This minimizes the adverse effects on the NV characteristics. Furthermore, the frequency of the harmonic Vh is lowered when the temperature of the motor unit 11 increases. This avoids overheating of the motor unit 11.
(2) The detection result of the phase current detector 22, which detects the phase currents Iu, Iv, and Iw flowing through the motor unit 11, is used as the temperature-associated value that is associated with the temperature of the motor unit 11.

This configuration obtains the temperature-associated value of the motor unit 11 without an additional configuration for detecting the temperature of the motor unit 11.
(3) The position estimator 32 estimates the position of the rotor 12 using the harmonic superposition method or the induced voltage method. Specifically, when the rotation speed Fm of the rotor 12 based on the estimation result is greater than or equal to the predetermined rotation speed Fmth, the position estimator 32 uses the induced voltage method to estimate the position of the rotor 12. When the rotation speed Fm of the rotor 12 based on the estimation result is less than the predetermined rotation speed Fmth, the position estimator 32 uses the harmonic superposition method to estimate the position of the rotor 12. When the position estimator 32 estimates the position of the rotor 12 by the induced voltage method, the harmonic superposer 41 does not superpose the harmonic Vh on the d-axis voltage instruction value Vd.

As the rotation speed Fm of the rotor 12 decreases, the induced voltage decreases. Therefore, if the rotation speed Fm of the rotor 12 is relatively low when the position estimator 32 estimates the position of the rotor 12 using the induced voltage method, the estimation accuracy may become lower. In this respect, the above configuration allows the position estimator 32 to accurately estimate the position of the rotor 12 using an appropriate one of the harmonic superposition method and the induced voltage method in accordance with the rotation speed Fm of the rotor 12. Furthermore, if the rotational speed Fm of the rotor 12 is relatively low when the refrigerant for cooling the motor unit 11 is circulated by the rotation of the motor unit 11, the flow rate of refrigerant may be reduced. This may cause overheating of the motor unit 11. Therefore, it is highly advantageous to lower the frequency of the harmonic Vh when the temperature of the motor unit 11 is relatively high, as in the above embodiment.
(4) The motor-driven compressor 101 includes the compression unit 102 that compresses the refrigerant, which is a fluid, and the electric motor M1 that drives the compression unit 102. The frequency of the harmonic Vh is switched when estimating the position of the rotor 12 by the harmonic superposition method, as described above. This avoids overheating of the motor unit 11 and minimizes the adverse effects on the NV characteristics. With this configuration, the vehicle air conditioner 100 including the motor-driven compressor 101 avoids overheating of the motor unit 11 and reduces the noise and vibration experienced by occupants in the passenger compartment.

The above embodiment may be modified as follows. The above embodiment and the following modifications can be combined as long as the combined modifications remain technically consistent with each other.

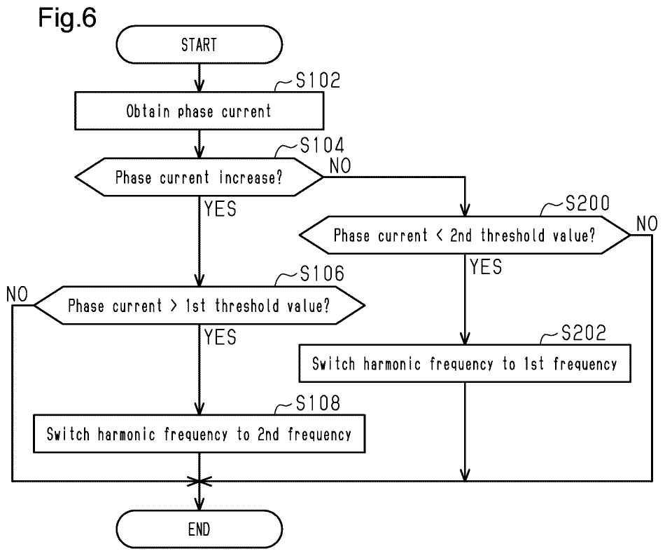

The harmonic superposition frequency switcher 44 switches the frequency of the harmonic Vh from the first frequency f1 to the second frequency f2 when the phase currents Iu, Iv, and Iw of the motor unit 11 are increased. However, there is no limit to such a configuration. The harmonic superposition frequency switcher 44 may switch the frequency of the harmonic Vh from the second frequency f2 to the first frequency f1 when the phase currents Iu, Iv, and Iw of the motor unit 11 are decreased. The details will now be described with reference to FIGS. 5 to 6.

When any of the phase currents Iu, Iv, and Iw of the motor unit 11 becomes less than or equal to the first threshold value Th1, the harmonic superposition frequency switcher 44 maintains the frequency of the harmonic Vh at the second frequency f2 while the phase currents Iu, Iv, and Iw are greater than or equal to a second threshold value Th2. The second threshold value Th2 is less than the first threshold value Th1. When the frequency of the harmonic Vh is the second frequency f2, the harmonic superposition frequency switcher 44 switches the frequency of the harmonic Vh to the first frequency f1 after any of the phase currents Iu, Iv, and Iw of the motor unit 11 becomes less than the second threshold value Th2. As described above, if any of the phase currents Iu, Iv, and Iw of the motor unit 11 becomes greater than the first threshold value Th1 when the frequency of the harmonic Vh is the first frequency f1, the harmonic superposition frequency switcher 44 switches the frequency of the harmonic Vh to the second frequency f2. That is, hysteresis is provided in the switching of the frequency of the harmonic Vh. A process that determines whether any of the phase currents Iu, Iv, and Iw detected by the phase current detector 22 becomes less than the second threshold value Th2 is an example of a process that determines whether the temperature-associated value of the motor unit 11 becomes less than the second threshold value Th2.

The series of processes related to the setting of the frequency of the harmonic Vh in accordance with the modified example will now be described with reference to FIG. 6. The flowchart shown in FIG. 6 includes steps S200 to S202, in addition to the process of the flowchart in FIG. 4.

When the phase currents Iu, Iv, and Iw are not increased (step S104: NO), the harmonic superposition frequency switcher 44 determines that the phase currents Iu, Iv, and Iw are decreased and determines whether any of the phase currents Iu, Iv, and Iw is less than the second threshold value Th2 (step S200). When the harmonic superposition frequency switcher 44 determines that none of the phase currents Iu, Iv, and Iw is less than the second threshold value Th2 (step S200: NO), the harmonic superposition frequency switcher 44 ends the series of processes. When the harmonic superposition frequency switcher 44 determines that any of the phase currents Iu, Iv, and Iw is less than the second threshold value Th2 (step S200: YES), the harmonic superposition frequency switcher 44 switches the frequency of the harmonic Vh from the second frequency f2 to the first frequency f1 (step S202). In this manner, the harmonic superposer 41 superposes the harmonic Vh having the first frequency f1 on the d-axis voltage instruction value Vd. Then, the controller 30 ends the series of processes.

This configuration appropriately switches the frequency of the harmonic Vh in accordance with the temperature of the motor unit 11. Further, hysteresis is provided in the switching of the frequency of the harmonic Vh, thereby avoiding frequent switching of the frequency of the harmonic Vh.

In the present modified example, the frequency of the harmonic Vh may be set to the second frequency f2 when the motor unit 11 is started.

The detection result of the phase currents Iu, Iv, and Iw detected by the phase current detector 22 is used as the temperature-associated value of the motor unit 11. However, there is no limit to such a configuration. Instead of (or in addition to) the detection result of the phase currents Iu, Iv, and Iw, other types of information may be used as the temperature-associated value of the motor unit 11. For example, in addition to the above configuration, the motor driving device 10 may include a temperature detector attached to the motor unit 11 and configured to detect the temperature of the motor unit 11. The temperature detector is implemented by, for example, a thermocouple and a functional unit that performs AD conversion on a measurement result of the thermocouple.

In this case, a detection result of the temperature detector is used as the temperature-associated value of the motor unit 11. The harmonic superposition frequency switcher 44 compares the temperature-associated value of the motor unit 11, which is based on the detection result of the temperature detector, with the first threshold value Th1 and the second threshold value Th2 to switch the frequency of the harmonic Vh. In this case, the first threshold value Th1 and the second threshold value Th2 are based on the heat resistance temperature of the motor unit 11. Specifically, the first threshold value Th1 indicates a temperature higher than the average temperature of the motor unit 11 in a normal state. The second threshold value Th2 is less than the first threshold value Th1.

The first threshold value Th1 does not have to be based on the average temperature of the motor unit 11 in a normal state. The first threshold value Th1 may be based on a statistical value, such as the median value, average value, mode value, or the like, of a temperature range achievable by the motor unit 11. Alternatively, the first threshold value Th1 may be based on a statistical value, such as the median value, average value, or the like, of a heat resistance temperature range of the motor unit 11.

The harmonic superposition frequency switcher 44 switches the frequency of the harmonic Vh based on the effective value of any of the phase currents Iu, Iv, and Iw detected by the phase current detector 22. However, there is no limit to such a configuration. The harmonic superposition frequency switcher 44 may switch the frequency of the harmonic Vh based on a statistical value, such as the median value, average value, maximum value, minimum value, or the like, of the phase currents Iu, Iv, and Iw detected by the phase current detector 22.

The position estimator 32 estimates the position of the rotor 12 using the harmonic superposition method or the induced voltage method. However, there is no limit to such a configuration. The position estimator 32 may estimate the position of the rotor 12 using only the harmonic superposition method.

The harmonic superposer 41 superposes the harmonic Vh on the d-axis voltage instruction value Vd. However, there is no limit to such a configuration. The harmonic superposer 41 may superpose the harmonic Vh on the current instruction values IdRef and IqRef.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An electric motor comprising:
a motor unit including a rotor and a stator around which three-phase coils are wound;
an inverter including a driver and a switching element operated by the driver, the inverter being configured to drive the motor unit through operation of the switching element;
a temperature-associated value obtainer configured to obtain a temperature-associated value that is associated with a temperature of the motor unit; and
processing circuitry configured to calculate instruction values for control of the switching element and control the switching element, wherein
the processing circuitry is configured to:
superpose a harmonic on at least one of the instruction values; and
estimate a position of the rotor by a harmonic superposition method based on the harmonic superposed on the at least one of instruction values,
a frequency of the harmonic includes a first frequency and a second frequency that is lower than the first frequency, and
the processing circuitry is further configured to:
determine whether the temperature-associated value becomes greater than a threshold value; and
set the frequency of the harmonic for superposition on the at least one of the instruction values to the second frequency when the temperature-associated value becomes greater than the threshold value.

2. The electric motor according to claim 1, wherein the frequency of the harmonic is set to the first frequency when the motor unit is started.

3. The electric motor according to claim 1, wherein
the threshold value is a first threshold value, and a second threshold value is less than the first threshold value, and
the processing circuitry is further configured to:
determine whether the temperature-associated value becomes less than the second threshold value when the frequency of the harmonic is the second frequency; and
set the frequency of the harmonic to the first frequency when the temperature-associated value becomes less than the second threshold value.

4. The electric motor according to claim 1, wherein
the temperature-associated value obtainer includes a phase current detector configured to detect a phase current flowing through the motor unit, and
the temperature-associated value includes a detection result of the phase current detector.

5. The electric motor according to claim 1, wherein
the temperature-associated value obtainer includes a temperature detector attached to the motor unit and configured to detect the temperature of the motor unit, and
the temperature-associated value includes a detection result of the temperature detector.

6. The electric motor according to claim 1, wherein
the processing circuitry is further configured to:
estimate the position of the rotor by an induced voltage method based on an induced voltage generated in the three-phase coils when a rotation speed of the rotor is greater than or equal to a predetermined rotation speed; and
estimate the position of the rotor by the harmonic superposition method when the rotation speed is less than the predetermined rotation speed, and
when the position of the rotor is estimated by the induced voltage method, the processing circuitry is further configured to not perform superposition of the harmonic.

7. A motor-driven compressor, comprising:
a compression unit configured to compress a fluid; and
the electric motor according to claim 1 and configured to drive the compression unit.
